(19) United States
(12) Patent Application Publication
(10) Pub. No.: US 2016/0006526 A1
(43) Pub. Date: Jan. 7, 2016

(54) SYSTEMS AND METHODS OF NETWORK CLOCK COMPARISON

(71) Applicant: QUALCOMM Incorporated, San Diego, CA (US)

(72) Inventors: James Simon CHO, Mountain View, CA (US); Alireza RAISSINIA, Monte Sereno, CA (US); Carlos Horacio ALDANA, Mountain View, CA (US); Xiaolong HUANG, San Jose, CA (US)

(21) Appl. No.: 14/754,343

(22) Filed: Jun. 29, 2015

Related U.S. Application Data
(60) Provisional application No. 62/020,925, filed on Jul. 3, 2014.

(51) Int. Cl. H04J 3/06

(52) U.S. Cl. CPC H04J 3/0661

(57) ABSTRACT

A method includes receiving, at a first device, a packet from a second device. The method also includes detecting receipt of the packet at a detection circuit. The method further includes, in response to detecting the receipt of the packet, capturing a time of arrival timestamp corresponding to the packet at a capture circuit. The method also includes receiving, at the first device, a time of departure timestamp corresponding to the packet from the second device. The time of departure timestamp indicates a time when the packet is sent from the second device. The method further includes performing a comparison of the time of arrival timestamp and the time of departure timestamp.

### I. CROSS-REFERENCE TO RELATED APPLICATIONS

The present application claims priority from U.S. Provisional Patent Application No. 62/020,925 filed on Jul. 3, 2014, the content of which is expressly incorporated by reference in its entirety.

### II. FIELD

The present disclosure is generally related to network clock comparison.

### III. DESCRIPTION OF RELATED ART

Advances in technology have resulted in smaller and more powerful computing devices. For example, there currently exist a variety of portable personal computing devices, including wireless computing devices, such as portable wireless telephones, personal digital assistants (PDAs), and paging devices that are small, lightweight, and easily carried by users. More specifically, portable wireless telephones, such as cellular telephones and internet protocol (IP) telephones, can communicate voice and data packets over wireless networks. Further, many such wireless telephones include other types of devices that are incorporated therein. For example, a wireless telephone can also include a digital still camera, a digital video camera, a digital recorder, and an audio file player. Also, such wireless telephones can process instructions, such as a web browser application that can be used to access the Internet. Memories, such as a memory within a wireless telephone or other electronic device, may store instructions in addition to other data.

Computing devices may, at times, perform synchronous operations. For example, a video source device, such as a camera, may capture video data. An audio source device, such as a microphone, may capture audio data. A computing device may receive the video data from the camera via a network and may receive the audio data from the microphone (via the network). The computing device may combine the audio data and the video data to produce a multimedia stream. The camera may timestamp the audio data based on a camera clock at the camera and the microphone may timestamp the video data based on a microphone clock at the microphone. The camera clock and the microphone clock may differ. For example, the camera clock and the microphone clock may be initialized to different values. Alternatively, even if the camera clock and the microphone clock are initialized to the same values at the same time, the camera clock and the microphone clock may drift over time. For example, the camera clock and the microphone clock may measure changes in time at different rates. The computing device may produce a multimedia stream by combining the audio data and the video data based on the timestamps of the audio data and the video data. The audio data and the video data may be incorrectly synchronized in the multimedia stream because the timestamps are based on clocks that differ.

### IV. SUMMARY

Systems and methods of network clock comparison are disclosed. In a particular aspect, a first device may send a first packet to a second device. The first packet may be a timestamp synchronization request. A detection circuit at the first device may assert a first timestamp capture signal in response to detecting transmission of the first packet. The detection circuit may operate at a first open systems interconnection model (OSI) layer. The first OSI layer may include a physical layer or a data link layer. There may be a delay between when (e.g., at 9:00:00 AM) the first packet is generated or received by a second OSI layer and when (e.g., at 9:00:02 AM) a first bit of the first packet is transmitted. For example, there may be a delay corresponding to the first packet passing through higher OSI layers to the first OSI layer for transmission. The higher OSI layers may include the second OSI layer. The second OSI layer may include an application layer, a presentation layer, a session layer, a transport layer, or a network layer. Having the detection circuit operate at the lower OSI layer may enable the detection circuit to assert the first timestamp capture signal closer to the time when the first bit of the first packet is transmitted. Having the first timestamp capture signal asserted closer to the time when the first bit of the first packet is transmitted may enable a more accurate time of departure (e.g., 9:00:02 AM compared to 9:00 AM) to be captured, as described herein.

A first clock register at the first device may correspond to a clock. For example, a value of the first clock register may be periodically updated. In a particular aspect, the first clock register may be periodically updated by a processor at the first device. A capture circuit at the first device may capture a time of departure (TOD) in response to a first timestamp capture signal by copying the TOD from the first clock register to a first shadow timestamp register. The TOD copied to the first shadow timestamp register may represent a snapshot of the first clock register at a time when the first clock register is read by the capture circuit in response to the first timestamp capture signal. A synchronization module at the first device may send the TOD to the second device.

The second device may receive the first packet. A detection circuit at the second device may assert a second timestamp capture signal in response to the first packet being received. There may be a delay between when (e.g., at 9:00:30 AM) the first packet is received at the second device and when (e.g., at 9:01) the first packet is passed from a first OSI layer to a higher OSI layer. For example, there may be a delay corresponding to the first packet passing through the OSI layers to the higher layer. The first OSI layer may include a physical layer and/or a data link layer. The higher OSI layer may include an application layer, a presentation layer, a session layer, a transport layer, or a network layer. Having the detection circuit operate at the lower OSI layer may enable the detection circuit to assert the second timestamp capture signal closer to the time when the first bit of the first packet is received at the second device. Having the second timestamp capture signal asserted closer to the time when the first bit of the first packet is received may enable a more accurate time of arrival (e.g., 9:00:30 AM compared to 9:01 AM) to be captured, as described herein.

A second clock register at the second device may correspond to a clock. A capture circuit at the second device may capture a time of arrival (TOA) in response to the second timestamp capture signal by copying the TOA from the second clock register to a second shadow timestamp register. The TOA copied to the second shadow timestamp register may represent a snapshot of the second clock register at a time when the second clock register is read by the capture circuit of the second device in response to the second timestamp capture signal.

The second device may receive the TOD from the first device. A synchronization module at the second device may read the TOA from the second shadow timestamp register and may compare the first clock register and the second clock register based on the TOA and the TOD. For example, the second device may synchronize the first clock register and the second clock register by determining an offset between the first clock register and the second clock register based on the comparison of the TOA and the TOD. The second device may store the offset in memory at the second device. In a particular aspect, the second device may use the offset to synchronize first data received from the first device with second data generated at the second device, where the first device timestamps the first data based on the first clock register and the second device timestamps the second data based on the second clock register. For example, the second device may add the offset to the timestamps of the first data to synchronize the first data with the second data.

The synchronization module at the second device may send the TOA to the first device. For example, the synchronization module at the second device may send the TOA to the first device based on determining that the first packet is a timestamp synchronization request. The first device may receive the TOA. The synchronization module at the first device may read the TOD from the first timestamp shadow register and may compare the first clock register and the second clock register based on the TOA and the TOD. For example, the first device may synchronize the first clock register and the second clock register by determining an offset between the first clock register and the second clock register based on a comparison of the TOA and the TOD. The first device may store the offset in memory at the first device. In a particular aspect, the first device may use the offset to synchronize first data generated at the first device with second data received from the second device, where the first device timestamps the first data based on the first clock register and the second device timestamps the second data based on the second clock register. For example, the first device may add the offset to the timestamps of the first data to synchronize the first data with the second data.

In a particular aspect, a computing device may synchronize a device clock at the computing device with a microphone clock at an audio source device. The audio source device may include a microphone. The computing device may synchronize the device clock with a camera clock at a video source device. The video source device may include a camera. To illustrate, the computing device may determine a first offset between the device clock and the microphone clock and may determine a second offset between the device clock and the camera clock. The computing device may receive audio data from the microphone and may receive video data from the camera. The microphone may timestamp the audio data based on the microphone clock and the camera may timestamp the video data based on the camera clock. The computing device may synchronize the audio data and the video data based on the first offset and the second offset. For example, the computing device may add the first offset to timestamps of the audio data and may add the second offset to timestamps of the video data. As another example, the computing device may add a difference of the first offset and the second offset to timestamps of the audio data or to the timestamps of the video data.

In a particular aspect, a method includes receiving, at a first device, a packet from a second device. The method also includes detecting receipt of the packet at a detection circuit. The method further includes, in response to detecting the receipt of the packet, capturing a time of arrival timestamp corresponding to the packet at a capture circuit. The method also includes receiving, at the first device, a time of departure timestamp corresponding to the packet from the second device. The time of departure timestamp indicates a time when the packet is sent from the second device. The method further includes performing a comparison of the time of arrival timestamp and the time of departure timestamp.

In another particular aspect, an apparatus includes a detection circuit, a capture circuit, a receiver, and a processor. The detection circuit is configured to detect transmission of a packet to a device. The capture circuit is responsive to the detection circuit. The capture circuit is configured to capture a time of departure timestamp corresponding to the packet in response to detecting, at the detection circuit, transmission of the packet. The receiver is configured to receive a time of arrival timestamp from the device. The time of arrival timestamp corresponds to the packet. The time of arrival timestamp indicates a time when the packet is received by the device. The processor is coupled to the detection circuit, the receiver, and the capture circuit. The processor is configured to compare the time of arrival timestamp and the time of departure timestamp.

In another particular aspect, a computer-readable storage device stores instructions that, when executed by a processor, cause the processor to perform operations including receiving a packet from a device and detecting receipt of the packet at a detection circuit. The operations also include, in response to detecting the receipt of the packet, capturing a time of arrival timestamp corresponding to the packet at a capture circuit. The operations further include receiving a time of departure timestamp corresponding to the packet from the device. The time of departure timestamp indicates a time when the packet is sent from the device. The operations also include performing a comparison of the time of arrival timestamp and the time of departure timestamp.

In another particular aspect, a device includes a receiver, a detection circuit, a capture circuit, and a processor. The receiver is configured to receive a packet from a second device and to receive a time of departure timestamp from the second device. The time of departure timestamp corresponds to the packet. The time of departure timestamp indicates a time when the packet is sent from the second device. The detection circuit is coupled to the receiver and is configured to detect receipt of the packet by the receiver. The capture circuit is responsive to the detection circuit. The capture circuit is configured to capture a time of arrival timestamp in response to detecting, at the detection circuit, the receipt of the packet by the receiver. The processor is coupled to the receiver and the capture circuit. The processor is configured to perform a comparison of the time of arrival timestamp and the time of departure timestamp.

One particular advantage provided by at least one of the disclosed aspects is comparison of clocks at distinct network devices based on a time of departure (TOD) of a packet at a first device and a time of arrival (TOA) of the packet at a second device. The disclosed techniques may enable clock synchronization across network devices based on the comparison. The disclosed techniques may enable clock synchronization by capturing TOA and TOD information using a detection circuit that operates at a lower level OSI layer. Other aspects, advantages, and features of the present disclosure will become apparent after review of the entire application, including the following sections: Brief Description of the Drawings, Detailed Description, and the Claims.

### V. BRIEF DESCRIPTION OF THE DRAWINGS

FIG. 1 is a diagram of a particular aspect of a system operable to perform network clock comparison;

FIG. 2 is a diagram of another particular aspect of a system operable to perform network clock comparison;

FIG. 3 is a particular aspect of a timing diagram corresponding to a network clock comparison performed by at least one of the systems of FIGS. 1-2;

FIG. 4 is a flow chart to illustrate a particular aspect of a method of network clock comparison that may be performed by at least one of the systems of FIGS. 1-2;

FIG. 5 is a flow chart to illustrate another particular aspect of a method of network clock comparison that may be performed by at least one of the systems of FIGS. 1-2; and

FIG. 6 is a block diagram of a device operable to perform network clock comparison in accordance with the systems and methods of FIGS. 1-5.

### VI. DETAILED DESCRIPTION

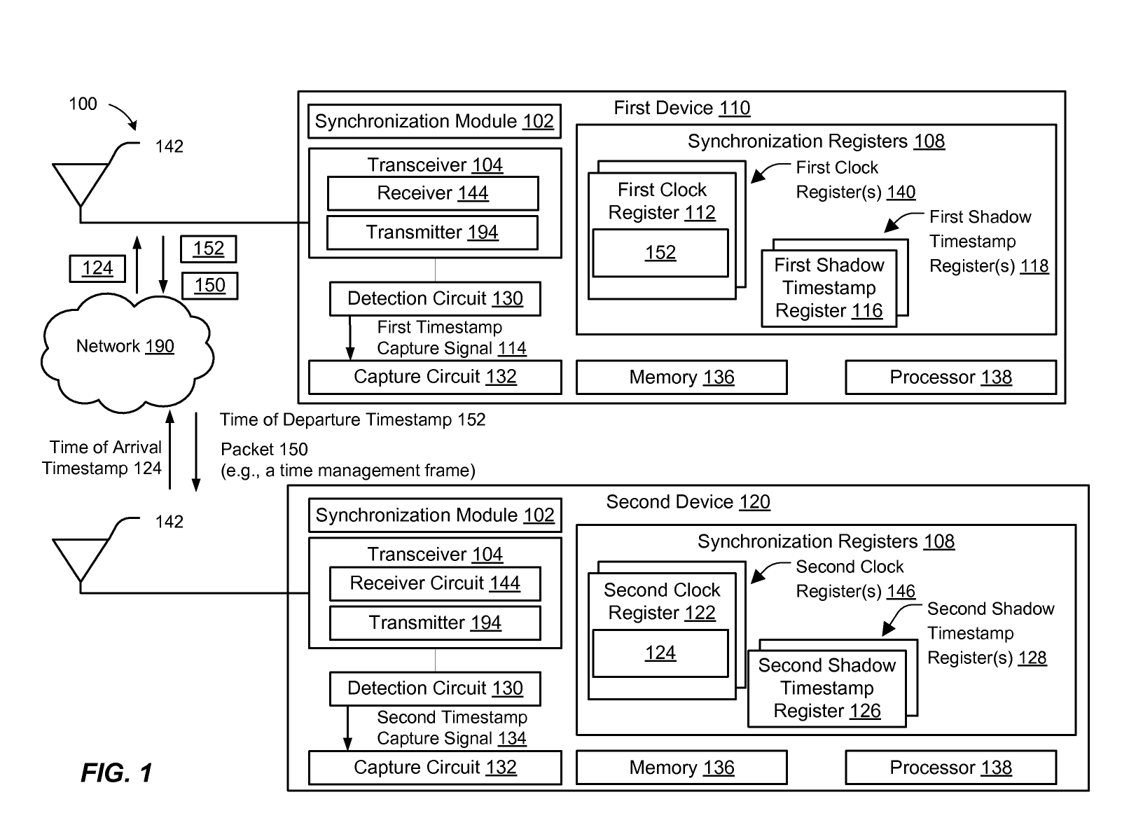

Referring to FIG. 1, a particular aspect of a system is shown and generally designated 100. The system 100 includes a first device 110 and a second device 120. Although the system 100 is illustrated as including two devices in FIG. 1, the system 100 may include more than two devices. The first device 110, the second device 120, or both, may include a synchronization module 102, a transceiver 104, a detection circuit 130, a capture circuit 132, a memory 136, a processor 138, synchronization registers 108, or a combination thereof. The transceiver 104 of the first device 110, the second device 120, or both, may include a transmitter 194, a receiver 144, or both. The first device 110, the second device 120, or both, may include an antenna 142. The detection circuit 130 of the first device 110 may be coupled, via the transceiver 104 of the first device 110, to the antenna 142 of the first device 110 and the detection circuit 130 of the second device 120 may be coupled, via the transceiver 104 of the second device 120, to the antenna 142 of the second device 120.

The synchronization registers 108 of the first device 110 may include one or more first clock registers 140, one or more first shadow timestamp registers 118, or a combination thereof. For example, the one or more first clock registers 140 may include a first clock register 112 and the one or more first shadow timestamp registers 118 may include a first shadow timestamp register 116. The synchronization registers 108 of the second device 120 may include one or more second clock registers 146, one or more second shadow timestamp registers 128, or a combination thereof. For example, the one or more second clock registers 146 may include a second clock register 122 and the one or more second shadow timestamp registers 128 may include a second shadow timestamp register 126.

During operation, the synchronization module 102 may generate a packet 150 to send to the second device 120. The packet 150 may be a timestamp synchronization request. For example, a particular value of a particular field of a header of the packet 150 may indicate that the packet 150 is a timestamp synchronization request. In a particular aspect, the synchronization module 102 may periodically generate the packet 150. In another aspect, the synchronization module 102 may generate the packet 150 in response to receiving a request from the processor 138. The request may be generated by a particular application. The particular application may include a multimedia stream generator application. In yet another aspect, the synchronization module 102 of the first device 110 may generate the packet 150 in response to receiving another timestamp synchronization request from the second device 120.

In a particular aspect, the synchronization module 102 may operate at a first OSI layer of the first device 110. The first OSI layer may include an application layer, a presentation layer, a session layer, a transport layer, and/or a network layer. For example, the synchronization module 102 may operate at an application layer to receive data from an application of the first device 110, may operate at a presentation layer to encrypt the application data, may operate at a session layer to generate session data by adding session information to the encrypted data, may operate at a transport layer to generate one or more segments based on the session data, and may operate at a network layer to generate one or more packets corresponding to the one or more segments.

The detection circuit 130 may operate at a second OSI layer of the first device 110. The second OSI layer may include a data link layer and/or a physical layer. For example, the detection circuit 130 may operate at a data link layer to generate one or more frames based on each of the one or more packets generated by the synchronization module 102 and may operate at a physical layer to generate one or more bits corresponding to each of the one or more frames. In a particular aspect, the detection circuit 130 may operate at a lower OSI layer than the synchronization module 102. For example, the detection circuit 130 may be a data link layer circuit and the synchronization module 102 may be an application layer module. The data link layer circuit may include a media access controller and the application layer module may include a central processing unit (CPU). The synchronization module 102 may provide the packet 150 to the detection circuit 130.

Operating at the lower OSI layer may enable the detection circuit 130 to detect when a transmission medium is available. For example, the detection circuit 130 may operate at a physical layer by communicating with the transmitter 194 and the receiver 144 to monitor the transmission medium. To illustrate, the detection circuit 130 may determine whether a transmission medium is available to transmit the packet 150. For example, the detection circuit 130 may use carrier sensing to determine whether a transmission medium is available. The detection circuit 130 may include a media access controller. In a particular aspect, the detection circuit 130 of the first device 110 may receive a signal via the receiver 144 of the first device 110 and may determine whether the signal indicates a carrier wave. The carrier wave may be from another node of the network 190. The detection circuit 130 of the first device 110 may determine that the transmission medium is unavailable in response to determining that the signal received from the receiver 144 of the first device 110 indicates a carrier wave. Alternatively, the detection circuit 130 of the first device 110 may determine that the transmission medium is available in response to determining that the signal received from the receiver 144 of the first device 110 does not indicate a carrier wave.

The detection circuit 130 may refrain from transmitting the packet 150 for a particular duration in response to determining that the transmission medium is unavailable. The particular duration may correspond to a default value. The detection circuit 130 may determine whether the transmission medium is available after the particular duration.

The detection circuit 130 may, in response to determining that the transmission medium is available, provide at least a first bit of the packet 150 to the transmitter 194. The detection circuit 130 may generate a first timestamp capture signal 114 in response to transmission of the packet 150. For example, the detection circuit 130 may detect transmission of the packet 150 in response to providing the at least first bit of the packet 150 to the transmitter 194. To illustrate, the detection circuit 130 may assert the first timestamp capture signal 114 in response to providing the first bit of the packet 150 to the transmitter 194. The transmitter 194 of the first device 110 may transmit the first bit of the packet 150 via the antenna 142 of the first device 110.

A value of the first clock register 112 may represent a clock. For example, the value of the first clock register 112 may be updated periodically. In a particular aspect, the processor 138 may periodically update the first clock register 112. The capture circuit 132 of the first device 110 may capture a time of departure timestamp 152 in response to the first timestamp capture signal 114. The first timestamp capture signal 114 may be an edge-triggered signal. For example, the detection circuit 130 may cause an input of the capture circuit 132 to transition from a first state (e.g., logic 0) to a second state (e.g., logic 1). The capture circuit 132 may detect that the first timestamp capture signal 114 is asserted in response to detecting the transition. In a particular implementation, the first timestamp capture signal 114 may be toggled between one logical state and another logical state. For example, the capture circuit 132 may detect that the first timestamp capture signal 114 is asserted while the input of the capture circuit 132 corresponds to the second state.

In a particular aspect, the first timestamp capture signal 114 may include a hardware signal, a software signal, or both. For example, the detection circuit 130 may send an interrupt request (e.g., IRQ) corresponding to a hardware signal to the capture circuit 132, may generate an exception corresponding to a software interrupt, or both. The capture circuit 132 may receive the interrupt request, may detect the exception, or both. In a particular aspect, the capture circuit 132 may execute an interrupt handler in response to the hardware signal, the software signal, or both. The interrupt handler may temporarily halt a miming process in response to the hardware signal, the software signal, or both. For example, the capture circuit 132 may halt thread execution and may save thread state to resume the thread execution subsequent to capturing the TOD timestamp 152. In a particular aspect, the capture circuit 132 may terminate the running process in response to the hardware signal, the software signal, or both.

The capture circuit 132 may operate at one or more OSI layers of the first device 110. The one or more OSI layers may include an application layer, a presentation layer, a session layer, a transport layer, and/or a network layer. For example, the capture circuit 132 may operate at an application layer to exchange data with an application of the first device 110 and may operate at a network layer to exchange packets with the detection circuit 130. To illustrate, the capture circuit 132 may receive first data from the application, may generate a first packet based on the first data, may provide the first packet to the detection circuit 130, may receive a second packet from the detection circuit 130, may generate second data based on the second packet, may provide the second data to the application, or a combination thereof. In a particular aspect, the capture circuit 132 may be an application layer circuit. The application layer circuit may include a CPU or a component of a CPU. In a particular implementation, the detection circuit 130 may include a first OSI layer circuit that operates at a first OSI layer and the capture circuit 132 may include a second OSI layer circuit that operates at a second OSI layer. The first OSI layer may be lower than the second OSI layer. The first OSI layer may include a data link layer and the second OSI layer may include an application layer. In a particular aspect, the capture circuit 132 may be coupled to, or included in, the processor 138.

The capture circuit 132 of the first device 110 may capture the TOD timestamp 152 by copying the TOD timestamp 152 from the first clock register 112 to the first shadow timestamp register 116. For example, the TOD timestamp 152 stored in the first shadow timestamp register 116 may be a snapshot of a value of the first clock register 112 at a time when the capture circuit 132 reads the value from the first clock register 112. The synchronization module 102 of the first device 110 may send the TOD timestamp 152 to the second device 120. For example, the synchronization module 102 of the first device 110 may read the TOD timestamp 152 from the first shadow timestamp register 116 and may send the TOD timestamp 152 via the network 190 to the second device 120. The first clock register 112 may have a first resolution (e.g., 60 megahertz) and another clock register, such as the second clock register 122, may have a second resolution (e.g., 100 megahertz). In a particular implementation, the synchronization module 102 may update the TOD timestamp 152 based on a clock domain synchronization error corresponding to a difference between the first resolution and the second resolution. In a particular aspect, the TOD timestamp 152 may indicate the clock domain synchronization error, such as plus or minus 10 nanoseconds.

In a particular aspect, the TOD timestamp 152 may be grey-coded. In grey coding, a single bit of a variable that represents a first value may be updated, so that the variable instead represents a next value. For example, in grey coding, a first value “1” may be represented by first bits “01” and a next value “2” may be represented by second bits “11,” such that the first bits differ from the second bits by a single bit position value.

In a particular aspect, the capture circuit 132 of the first device 110 may send a captured status to the synchronization module 102 of the first device 110 subsequent to copying the TOD timestamp 152 to the first shadow timestamp register 116. The captured status may indicate that a time of departure (TOD) timestamp (e.g., the TOD timestamp 152) is copied to the first shadow timestamp register 116. The captured status may also indicate that the TOD timestamp 152 corresponds to a time when the packet 150 is sent to the second device 120. In this aspect, the synchronization module 102 of the first device 110 may send the TOD timestamp 152 to the second device 120 in response to receiving the captured status.

The second device 120 may receive the packet 150 via the network 190 from the first device 110. For example, the receiver 144 of the second device 120 may receive the packet 150 via the antenna 142 of the second device 120. In a particular implementation, the detection circuit 130 detects receipt of the packet 150 without decoding the packet 150. For example, the detection circuit 130 may detect receipt of the packet 150 in response to detecting that a first bit of the packet 150 is received, where the first bit is an earliest received bit of the packet 150. In a particular implementation, the detection circuit 130 of the second device 120 asserts a second timestamp capture signal 134 in response to detecting that at least a first bit of the packet 150 is received. For example, the detection circuit 130 of the second device 120 may assert the second timestamp capture signal 134 in response to detecting that the first bit is received by the receiver 144 of the second device 120. To illustrate, the detection circuit 130 of the second device 120 may detect at a first time that a transmission medium is available and may, at a second time, detect a carrier signal on the transmission medium. The carrier signal may be from another node of the network 190. The detection circuit 130 of the second device 120 may assert the second timestamp capture signal 134 at the second time.

In a particular implementation, the capture circuit 132 of the second device 120 captures a time of arrival (TOA) timestamp 124 in response to the second timestamp capture signal 134. For example, the capture circuit 132 of the second device 120 may copy the TOA timestamp 124 from the second clock register 122 to the second shadow timestamp register 126. The TOA timestamp 124 stored in the second shadow timestamp register 126 may be a snapshot of a value of the second clock register 122 at a time when the capture circuit 132 reads the TOA timestamp 124 from the second clock register 122. The synchronization module 102 of the second device 120 may read the TOA timestamp 124 from the second shadow timestamp register 126 and may send the TOA timestamp 124 via the network 190 to the first device 110.

The clock registers 112, 122 may have different resolutions. For example, the first clock register 112 may have a resolution of 60 megahertz and the second clock register 122 may have a resolution of 100 megahertz. In a particular implementation, the synchronization module 102 of the second device 120 may update the TOA timestamp 124 based on a clock domain synchronization error. The clock domain synchronization error may correspond to a difference between the resolutions of the clock registers 112, 122. In a particular aspect, the TOA timestamp 124 may indicate the clock domain synchronization error (e.g., plus or minus 10 nanoseconds). In a particular aspect, the TOA timestamp 154 may be grey-coded.

In a particular aspect, the capture circuit 132 of the second device 120 may send a captured status to the synchronization module 102 of the second device 120 subsequent to copying the TOA timestamp 124 to the second shadow timestamp register 126. The captured status may indicate that a time of arrival (TOA) timestamp (e.g., the TOA timestamp 124) is copied to the second shadow timestamp register 126. The captured status may also indicate that the TOA timestamp 124 corresponds to a time when the packet 150 is received by the first device 110. In this aspect, the synchronization module 102 of the second device 120 may send the TOA timestamp 124 to the first device 110 in response to receiving the captured status.

In a particular aspect, prior to sending the TOA timestamp 124 to the first device 110, the synchronization module 102 of the second device 120 may determine whether to retain or discard the TOA timestamp 124 in the second shadow timestamp register 126 based on a particular value of a particular field of a header of the packet 150. For example, the synchronization module 102 of the second device 120 may retain the TOA timestamp 124 in response to determining that the particular value indicates that the packet 150 is a timestamp synchronization request. As another example, the synchronization module 102 of the second device 120 may discard the TOA timestamp 124 in response to determining that the packet 150 is incorrectly received, in response to determining that the first device 110 is not indicated as a recipient of the packet 150, in response to determining that the particular value indicates that the packet 150 is not a timestamp synchronization request, or a combination thereof. In a particular aspect, the synchronization module 102 of the second device 120 may discard the TOA timestamp 124 by marking the second shadow timestamp register 126 as available. In a particular aspect, the synchronization module 102 of the second device 120 may determine that the packet 150 is incorrectly received in response to determining that the packet 150 contains an invalid error correction code.

The synchronization module 102 of the first device 110 may receive the TOA timestamp 124 from the second device 120. For example, the receiver 144 of the first device 110 may receive the TOA timestamp 124 via the antenna 142 of the first device 110. The receiver 144 of the first device 110 may store the TOA timestamp 124 in the memory 136 of the first device 110.

The synchronization module 102 of the second device 120 may receive the TOD timestamp 152 from the first device 110. For example, the receiver 144 of the second device 120 may receive the TOD timestamp 152 via the antenna 142 of the second device 120. The receiver 144 of the second device 120 may store the TOD timestamp 152 in the memory 136 of the second device 120.

The synchronization module 102 of the first device 110, the second device 120, or both, may compare the TOA timestamp 124 and the TOD timestamp 152. The synchronization module 102 of the first device 110, the second device 120, or both, may synchronize the first clock register 112 and the second clock register 122 based on the comparison. In a particular aspect, the synchronization module 102 may synchronize the first clock register 112 and the second clock register 122 by determining an offset between the first clock register 112 and the second clock register 122 based on a difference between the TOA timestamp 124 and the TOD timestamp 152. The synchronization module 102 may store the offset in the memory 136. For example, the synchronization module 102 of the first device 110 may store the offset in the memory 136 of the first device 110. As another example, the synchronization module 102 of the second device 120 may store the offset in the memory 136 of the second device 120.

The synchronization module 102 of the first device 110 may use the offset to synchronize first data generated at the first device 110 with second data received from the second device 120, where the first device 110 timestamps the first data based on the first clock register 112 and the second device 120 timestamps the second data based on the second clock register 122. For example, the first device 110 may add the offset to the timestamps of the first data to synchronize the first data with the second data. Similarly, the synchronization module 102 of the second device 120 may use the offset to synchronize first data received from the first device 110 with second data generated at the second device 120, where the first device 110 timestamps the first data based on the first clock register 112 and the second device 120 timestamps the second data based on the second clock register 122. For example, the second device 120 may add the offset to the timestamps of the first data to synchronize the first data with the second data.

In an alternate aspect, the synchronization module 102 of the first device 110 (or the second device 120) may synchronize the first clock register 112 and the second clock register 122 by updating a value of the first clock register 112 (or the second clock register 122) based on the TOA timestamp 124 and the TOD timestamp 152. For example, the synchronization module 102 of the first device 110 (or the second device 120) may determine the offset based on the difference between the TOA timestamp 124 and the TOD timestamp 152 and may add the offset to the value of the first clock register 112 (or the second clock register 122). In this aspect, one of the first device 110 and the second device 120 may be a slave device and the other of the first device 110 and the second device 120 may be a master device. For example, the first device 110 may be a slave device that updates a value of the first clock register 112 to synchronize with the second clock register 122 of the second device 120. As another example, the first device 110 may be a master device and the second device 120 may update a value of the second clock register 122 to synchronize with the first clock register 112 of the first device 110.

In a particular aspect, synchronization of the clock registers 112 and 122 based on the TOA timestamp 124 and the TOD timestamp 152 may account for a transmission latency related to transmitting the packet 150 from the first device 110 to the second device 120. For example, the first clock register 112 may indicate a first sender clock value (e.g., 200 time units) when a first bit of the packet 150 is transmitted and the TOD timestamp 152 may indicate the first sender clock value (e.g., 200 time units). The first clock register 112 may indicate a second sender clock value (e.g., 300 time units) when a first bit of the packet 150 is received by the second device 120 corresponding to a transmission latency related to transmission of the packet 150 from the first device 110 to the second device 120.

The second clock register 122 may indicate a first receiver clock value (e.g., 500 time units) when the first bit of the packet 150 is transmitted by the first device 110 and may indicate a second receiver clock value (e.g., 600 time units) when the first bit of the packet 150 is received by the second device 120. The TOA timestamp 124 may indicate the second receiver value (e.g., 600 time units).

The synchronization module 102 may synchronize the first clock register 112 and the second clock register 122 based on the first sender clock value (e.g., 200 time units) and the second receiver clock value (e.g., 600 time units) indicated by the TOD timestamp 152 and the TOA timestamp 124, respectively, even though the first clock register 112 indicated the first sender clock value when the second clock register 122 indicated the first receiver clock value and the first clock register 112 indicated the second sender clock value when the second clock register 122 indicated the second receiver clock value.

Synchronizing the first clock register 112 and the second clock register 122 based on the first sender clock value and the second receiver clock value may account for the transmission latency. For example, the synchronization module 102 of the second device 120 may determine the offset (e.g., 600−200=400 time units) based on the first sender clock value and the second receiver clock value. If the first device 110 sends a notification to the second device 120 indicating that the first device 110 is to send a message at a particular sender time (e.g., 1000 time units) of the first clock register 112, the second device 120 may expect the message at a particular receiver time (e.g., 1400 time units) of the second clock register 122 based on the offset. Since the offset takes account of the transmission latency, the particular receiver time may correspond to a value of the second clock register 122 when the message is received by the second device 120 which may be higher than a value (e.g., 1300 time units) of the second clock register 122 when the message is transmitted by the first device 110.

In a particular aspect, operations performed by the first device 110 and the second device 120 may be performed by a single device. For example, the first device 110 may generate the TOD timestamp 152 corresponding to the packet 150, as described herein, and may generate a TOA timestamp corresponding to another packet received from another device (e.g., the second device 120 or a third device). To illustrate, the detection circuit 130 of the first device 110 may assert another timestamp capture signal in response to receiving the other packet.

The first timestamp capture signal 114 and the other timestamp capture signal may be independent sideband probe signals. For example, the detection circuit 130 may assert a first sideband probe signal in response to transmission of a packet and may assert a second sideband probe signal in response to receiving a packet. To illustrate, the detection circuit 130 may assert the first timestamp capture signal 114 in response to transmission of the packet 150 and may assert the other timestamp capture signal in response to receiving the other packet. The capture circuit 132 may determine whether a time of arrival timestamp is to be captured or a time of departure timestamp is to be captured based on which sideband probe signal is asserted. For example, the first sideband probe signal may indicate to the capture circuit 132 that a time of departure timestamp is to be captured. As another example, the second sideband probe signal may indicate to the capture circuit 132 that a time of arrival timestamp is to be captured.

The capture circuit 132 of the first device 110 may capture another TOA timestamp in response to the other timestamp capture signal. For example, the capture circuit 132 of the first device 110 may copy the other TOA timestamp from a clock register (e.g., the first clock register 112) of the one or more first clock registers 140 to another shadow timestamp register of the one or more first shadow timestamp registers 118.

The receiver 144 of the first device 110 may receive another TOD timestamp from the other device and may store the other TOD timestamp in the memory 136. The synchronization module 102 may read the other TOD timestamp from the memory 136, may read the other TOA timestamp from the other shadow timestamp register, and may compare the other TOA timestamp and the TOD timestamp. The synchronization module 102 may synchronize the first clock register 112 and another clock register at the other device based on the comparison. The synchronization module 102 may send the TOA timestamp to the other device. Similarly, the second device 120 may generate the TOA timestamp 124 corresponding to the packet 150, as described herein, and may generate a TOD timestamp corresponding to another packet sent to another device (e.g., the first device 110 or a third device).

In a particular aspect, the first clock register 112 and the second clock register 122 may correspond to a first application. The first application may include a multimedia stream generation application. For example, the multimedia stream generation application at the second device 120 may generate audio data and may timestamp the audio data based on the second clock register 122. The multimedia stream generation application at the first device 110 may generate video data and may timestamp the video data based on the first clock register 112. The first device 110 may synchronize the first clock register 112 and the second clock register 122 to synchronize the audio data received from the second device 120 with the video data generated at the first device 110.

In a particular aspect, another first clock register of the one or more first clock registers 140 and another second clock register of the one or more second clock registers 146 may correspond to a second application. The second application may include a video gaming application. For example, the video gaming application at the first device may generate first user data corresponding to a first user and may timestamp the first user data based on the other first clock register. The video gaming application at the second device may generate second user data corresponding to a second user and may timestamp the second user data based on the other second clock register. The first device 110 may synchronize the other first clock register and the other second clock register to synchronize the first user data generated at the first device 110 with the second user data received from the second device.

In a particular aspect, the first device 110 may synchronize multiple clock registers at the first device (e.g., the first clock register 112 and the other first clock register) with multiple clock registers at the second device (e.g., the second clock register 122 and the other second clock register) based on the packet 150. In a particular aspect, each clock register of the multiple clock registers at the first device and a corresponding clock register of the multiple clock registers at the second device may correspond to a particular application. For example, the first clock register 112 and the second clock register 122 may correspond to a first application and another first clock register of the first clock registers 140 and another second clock register of the second clock registers 146 may correspond to a second application. In a particular aspect, the first application may include a multimedia application and the second application may include a gaming application. In a particular aspect, one or more of the multiple clock registers at the first device 110 may have distinct values, may have distinct rates at which a value of the one or more clock registers is changed, or both. In a particular aspect, one or more of the multiple clock registers at the second device 120 may have distinct values, may have distinct rates at which a value of the one or more clock registers is changed, or both.

The first device 110 may compare a TOA timestamp of each of the multiple clock registers at the first device 110 with a TOD timestamp of a corresponding clock register of the multiple clock registers at the second device 120. The TOA timestamp of each of the multiple clock registers at the first device 110 may correspond to a time when the packet 150 is received by the first device 110. The TOD timestamp of each of the multiple clock registers at the second device 120 may correspond to a time when the packet 150 is sent by the second device 120. For example, the capture circuit 132 of the first device 110 may capture a plurality of TOA timestamps in response to the first timestamp capture signal 114. For example, the capture circuit 132 of the first device 110 may copy the plurality of TOA timestamps from a plurality of first clock registers of the one or more first clock registers 140 to a plurality of first shadow timestamp registers of the one or more first shadow timestamp registers 118. The plurality of TOA timestamps may include the TOA timestamp 124, the plurality of first clock registers may include the first clock register 112, and the plurality of first shadow timestamp registers may include the first shadow timestamp register 116.

In a particular aspect, the capture circuit 132 of the second device 120 may capture a plurality of TOD timestamps in response to the second timestamp capture signal 134. For example, the capture circuit 132 of the second device 120 may copy the plurality of TOD timestamps from a plurality of second clock registers of the one or more second clock registers 146 to a plurality of second shadow timestamp registers of the one or more second shadow timestamp registers 128. The plurality of TOD timestamps may include the TOD timestamp 152, the plurality of second clock registers may include the second clock register 122, and the plurality of second shadow timestamp registers may include the second shadow timestamp register 126.

The receiver 144 of the first device 110 may receive the plurality of TOD timestamps from the second device 120 and may store the plurality of TOD timestamps in the memory 136 of the first device 110. The receiver 144 of the second device 120 may receive the plurality of TOA timestamps from the first device 110 and may store the plurality of TOA timestamps in the memory 136 of the second device 120.

The synchronization module 102 of the first device 110 (or the second device 120) may synchronize the plurality of first clock registers with the plurality of second clock registers based on the plurality of TOA timestamps and the plurality of TOD timestamps. For example, the synchronization module 102 of the first device 110 (or the second device 120) may determine a plurality of offsets corresponding to a difference between the plurality of TOA timestamps and the plurality of TOD timestamps and may store the plurality of offsets in the memory 136 of the first device 110 (or the second device 120). As another example, the synchronization module 102 of the first device 110 (or the second device 120) may update values of the plurality of first clock registers (or the plurality of second clock registers) based on a difference between the plurality of TOA timestamps and the plurality of TOD timestamps.

The system 100 may enable comparison of the TOD timestamp 152 corresponding to a time when a packet 150 is transmitted by the first device 110 and the TOA timestamp 124 corresponding to a time when the packet 150 is received by the second device 120. The TOD timestamp 152 captured by the detection circuit 130 of the first device 110 may be accurate because the TOD timestamp 152 may correspond to a time when a first bit of the packet 150 is transmitted by the transceiver 104 of the first device 110. The TOA timestamp 124 captured by the detection circuit 130 of the second device 120 may be accurate because the TOA timestamp 124 may correspond to a time when a first bit of the packet 150 is received by the transceiver 104 of the second device 120. The system 100 may enable synchronization of the first clock register 112 of the first device 110 and the second clock register 122 of the second device 120 based on the comparison.

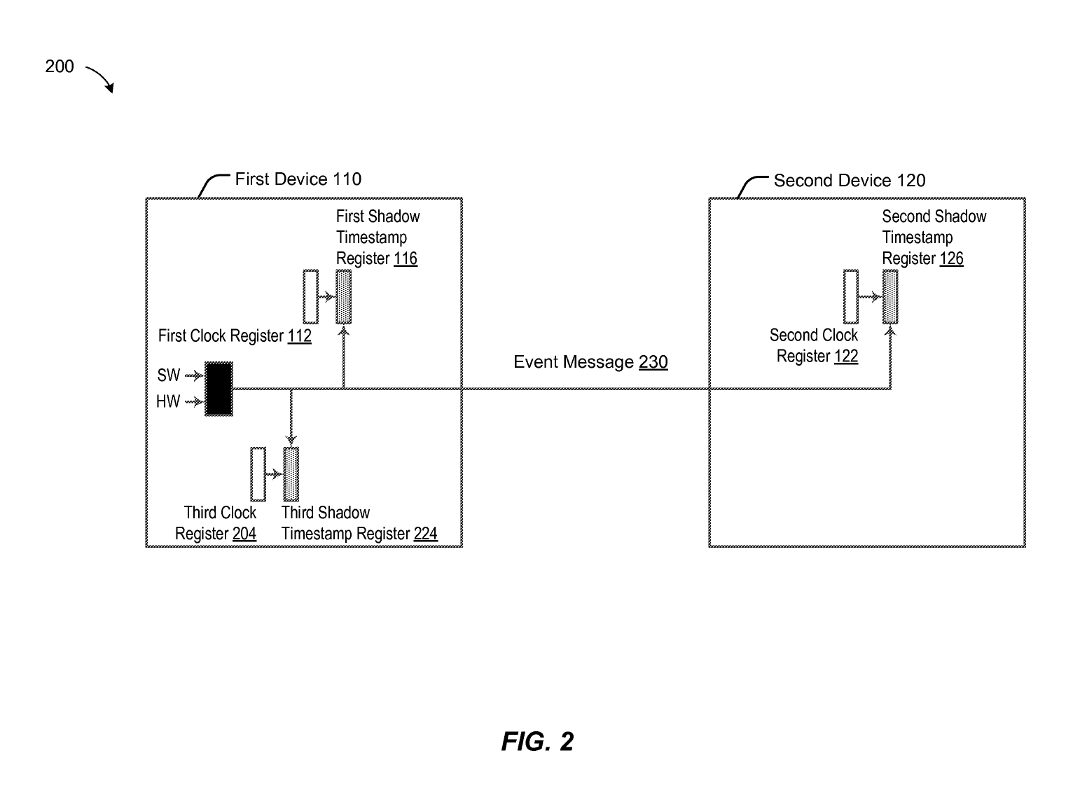

Referring to FIG. 2, a diagram of a particular aspect of a system is shown and generally designated 200. In a particular aspect, the system 200 may correspond to the system 100 of FIG. 1. The system 200 includes the first device 110 and the second device 120.

During operation, a synchronization module 102 of FIG. 1 of the first device 110 may receive a timestamp synchronization request. The timestamp synchronization request may correspond to a management frame. The timestamp synchronization request may be generated by software or hardware at the first device 110. In response to the timestamp synchronization request, the synchronization module 102 of the first device 110 may generate an event message 230 (e.g., the packet 150 of FIG. 1) and may send the event message 230 (e.g., the packet 150) to the second device 120. The detection circuit 130 of FIG. 1 of the first device 110 may assert the first timestamp capture signal 114 in response to transmission of a first bit of the event message 230 (e.g., the packet 150), as described with reference to FIG. 1.

The capture circuit 132 of FIG. 1 of the first device 110 may capture the time of departure (TOD) timestamp 152 in response to the first timestamp capture signal 114, as described with reference to FIG. 1. For example, the capture circuit 132 of the first device 110 may copy the TOD timestamp 152 from the first clock register 112 to the first shadow timestamp register 116. The capture circuit 132 of the first device 110 may also capture another TOD timestamp in response to the first timestamp capture signal 114. For example, the capture circuit 132 may copy the other TOD timestamp from a third clock register 204 to a third shadow timestamp register 224. The one or more first clock registers 140 may include the third clock register 204 and the one or more first shadow timestamp registers 118 may include the third shadow timestamp register 224.

The second device 120 may receive the event message 230 (e.g., the packet 150). The detection circuit 130 of the second device 120 may generate the second timestamp capture signal 134 in response to a first bit of the event message 230 being received by the second device 120, as described with reference to FIG. 1. The capture circuit 132 of the second device 120 may capture the TOA timestamp 124 in response to the second timestamp capture signal 134. For example, the capture circuit 132 of the second device 120 may copy the TOA timestamp 124 from the second clock register 122 to the second shadow timestamp register 126. The synchronization module 102 of the first device 110 may read the TOD timestamp 152 from the first shadow timestamp register 116, may read the other TOD timestamp from the third shadow timestamp register 224, and may send the TOD timestamp 152, the other TOD timestamp, or both, to the second device 120. The second device 120 may read the TOA timestamp 124 from the second shadow timestamp register 126 and may send the TOA timestamp 124 to the first device 110.

In the aspect illustrated in FIG. 2, the first device 110 and the second device 120 may synchronize multiple first clock registers (e.g., the first clock register 112 and the third clock register 204) at the first device 110 with the second clock register 122 of the second device 120. For example, the synchronization module 102 of the first device 110 (or the second device 120) may determine a first offset between the first clock register 112 and the second clock register 122 based on the TOD timestamp 152 and the TOA timestamp 124 and may determine a second offset between the third clock register 204 and the second clock register 122 based on the other TOD timestamp and the TOA timestamp 124. The synchronization module 102 of the first device 110 (or the second device 120) may synchronize first timestamps of first data generated at the first device 110 (or the second device 120) with second timestamps of second data received from the second device 120 (or the first device 110). For example, the synchronization module 102 of the first device 110 (or the second device 120) may add the offset to the first timestamps or to the second timestamps. As another example, the synchronization module 102 of the first device 110 may update a value of the first clock register 112 based on a difference between the TOD timestamp 152 and the TOA timestamp 124 and may update a value of the third clock register 204 based on a difference between the other TOD timestamp and the TOA timestamp 124.

The system 200 may thus enable comparison of multiple TOD timestamps at the first device 110 corresponding to a time when the event message 230 is transmitted from the first device 110 with a TOA timestamp at the second device 120 corresponding to a time when the event message 230 is received by the second device 120. The multiple TOD timestamps may correspond to when a first bit of the event message 230 is transmitted and the TOA timestamp may correspond to when a first bit of the event message 230 is received, resulting in an accurate comparison. The system 200 may enable clock synchronization based on the accurate comparison.

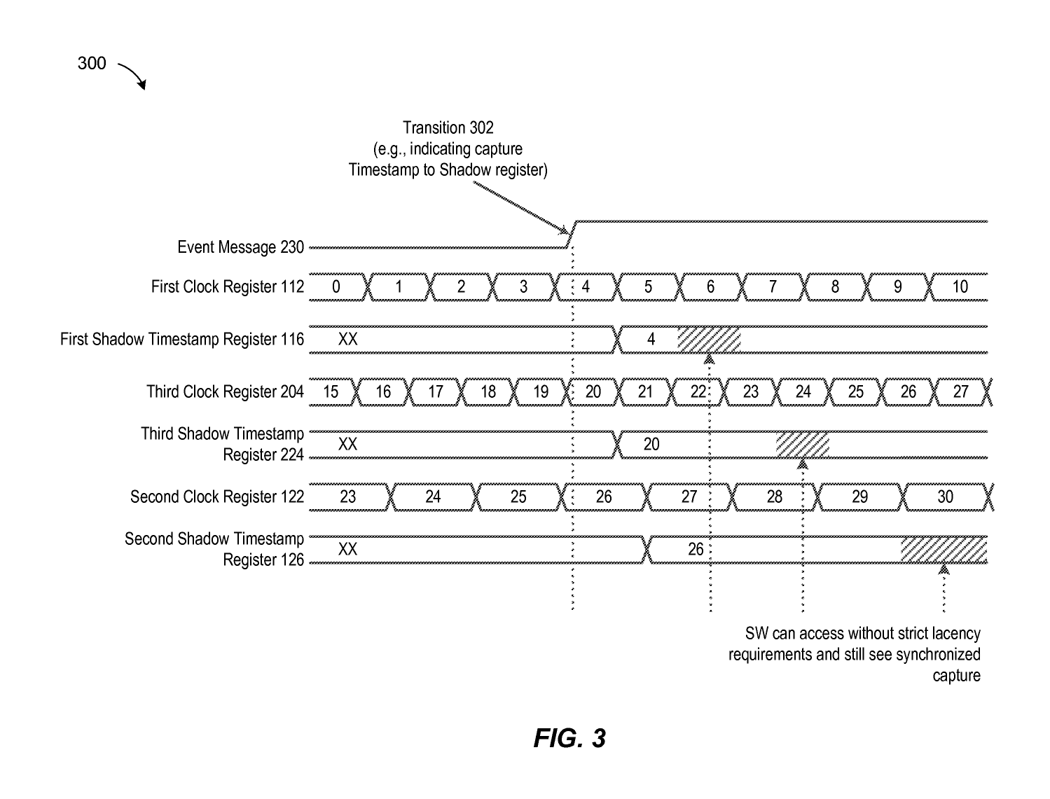

Referring to FIG. 3, a particular aspect of a timing diagram is shown and generally designated 300. The timing diagram 300 may correspond to network clock comparison performed by at least one of the systems 100-200 of FIGS. 1-2.

As illustrated in the timing diagram 300, the first clock register 112, the second clock register 122, and the third clock register 204 may have distinct values and may operate at distinct rates. For example, a value of the first clock register 112 may be updated at a first periodic interval, a value of the second clock register 122 may be updated at a second periodic interval, and a value of the third clock register may be updated at a third periodic interval.

During operation, the detection circuit 130 of the first device 110 of FIG. 1 may assert the first timestamp capture signal 114 in response to transmission of the event message 230 (e.g., the packet 150), as described with reference to FIGS. 1-2. The first timestamp capture signal 114 may be an edge-triggered signal, as described with reference to FIG. 1. For example, a transition 302 of the timing diagram 300 may correspond to the first timestamp capture signal 114. The capture circuit 132 of the first device 110 may copy the TOD timestamp 152 (e.g., 4) from the first clock register 112 to the first shadow timestamp register 116 in response to the first timestamp capture signal 114, as described with reference to FIGS. 1-2. The capture circuit 132 of the first device 110 may copy another TOD timestamp (e.g., 20) from the third clock register 204 to the third shadow timestamp register 224 in response to the first timestamp capture signal 114, as described with reference to FIG. 2.

In a particular aspect, the transition 302 may correspond to the second timestamp capture signal 134 of the second device 120 of FIG. 1. For example, the transition 302 may correspond to the second timestamp capture signal 134 that is asserted by the detection circuit 130 of the second device 120 in response to receiving the event message 230, as described with reference to FIG. 2. The capture circuit 132 of the second device 120 of FIG. 1 may capture the TOA timestamp 124 in response to the second timestamp capture signal 134, as described with reference to FIGS. 1-2. For example, the capture circuit 132 may copy the TOA timestamp 124 (e.g., 26) from the second clock register 122 to the second shadow timestamp register 126.

The values of the first shadow timestamp register 116, the second shadow timestamp register 126, and the third shadow timestamp register 224 may be snapshots of values of the first clock register 112, the second clock register 122, and the third clock register 204, respectively. The snapshots may correspond to a time related to the transition 302. In a particular aspect, the synchronization module 102 of the first device 110 (or the second device 120) may compare values of the first shadow timestamp register 116, the second shadow timestamp register 126, and/or the third shadow timestamp register 224 with no or reduced latency concerns. For example, the values of the first shadow timestamp register 116, the second shadow timestamp register 126, and the third shadow timestamp register 224 may be read at distinct times and yet may represent a substantially similar capture time corresponding to the transition 302.

The timing diagram 300 may thus correspond to comparison of TOD timestamps corresponding to a time when an event message is transmitted by a first device with a TOA timestamp corresponding to a time when the event message is received by a second device.

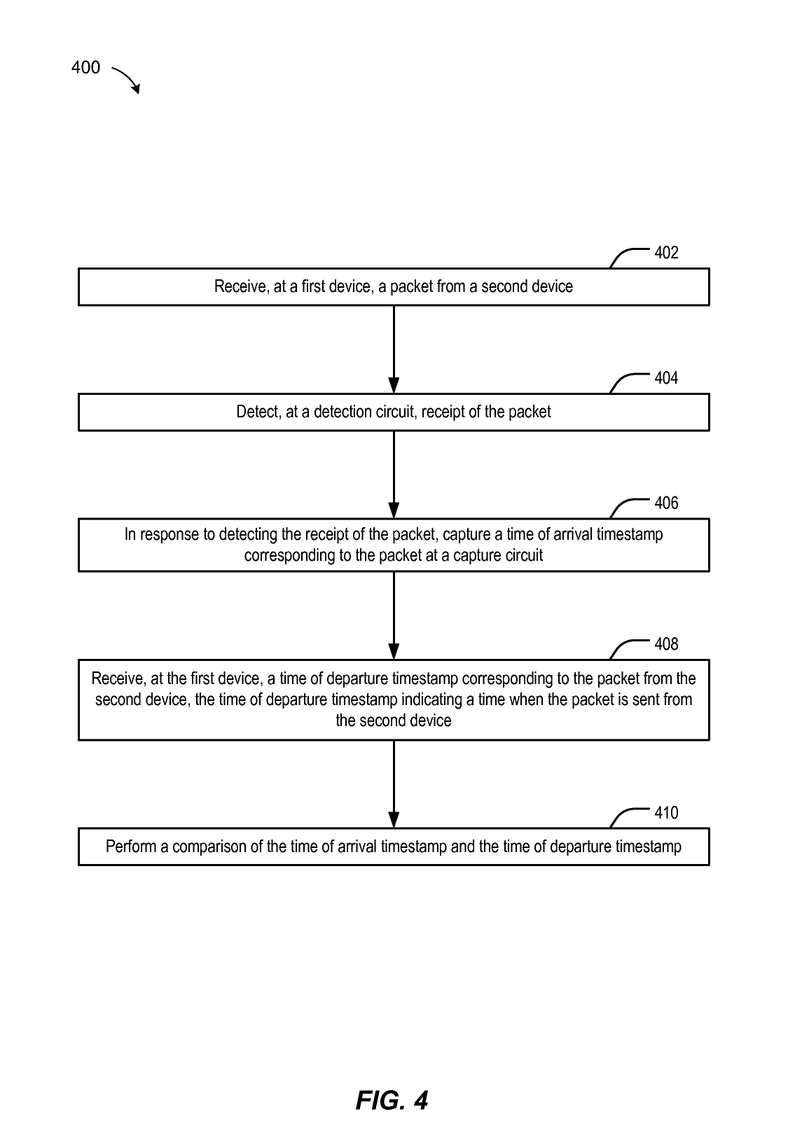

Referring to FIG. 4, a particular aspect of a method of network clock comparison is shown and generally designated 400. In a particular aspect, the method 400 may be performed by at least one of the systems 100-200 of FIGS. 1-2.

The method 400 includes receiving, at a first device, a packet from a second device, at 402. For example, the second device 120 of FIG. 1 may receive the packet 150 from the first device 110, as described with reference to FIG. 1.

The method 400 also includes detecting, at a detection circuit, receipt of the packet, at 404. For example, the detection circuit 130 of the second device 120 of FIG. 1 may detect receipt of the packet 150, as described with reference to FIG. 1. The detection circuit 130 may assert the second timestamp capture signal 134 in response to receiving the packet 150 from the first device 110.

The method 400 further includes, in response to detecting the receipt of the packet, capturing a time of arrival timestamp corresponding to the packet at a capture circuit, at 406. For example, the capture circuit 132 of the second device 120 of FIG. 1 may capture the TOA timestamp 124 in response to the detection circuit 130 detecting the receipt of the packet 150, as described with reference to FIG. 1. The capture circuit 132 may capture the TOA timestamp 124 in response to the second timestamp capture signal 134.

The method 400 also includes receiving a time of departure timestamp corresponding to the packet from the second device, at 408. The time of departure timestamp may indicate a time when the packet is sent from the second device. For example, the second device 120 of FIG. 1 may receive the TOD timestamp 152 corresponding to the packet 150 from the first device 110, as described with reference to FIG. 1. The TOD timestamp 152 may indicate a time when the packet 150 is sent from the first device 110, as described with reference to FIG. 1.

The method 400 further includes performing a comparison of the time of arrival timestamp and the time of departure timestamp, at 410. For example, the synchronization module 102 of the second device 120 of FIG. 1 may compare the TOA timestamp 124 and the TOD timestamp 152, as described with reference to FIG. 1.

The method 400 may thus enable the synchronization module 102 of the second device 120 to compare the TOD timestamp 152 corresponding to a time when the packet 150 is transmitted by the first device 110 and the TOA timestamp 124 corresponding to a time when the packet 150 is received by the second device 120.

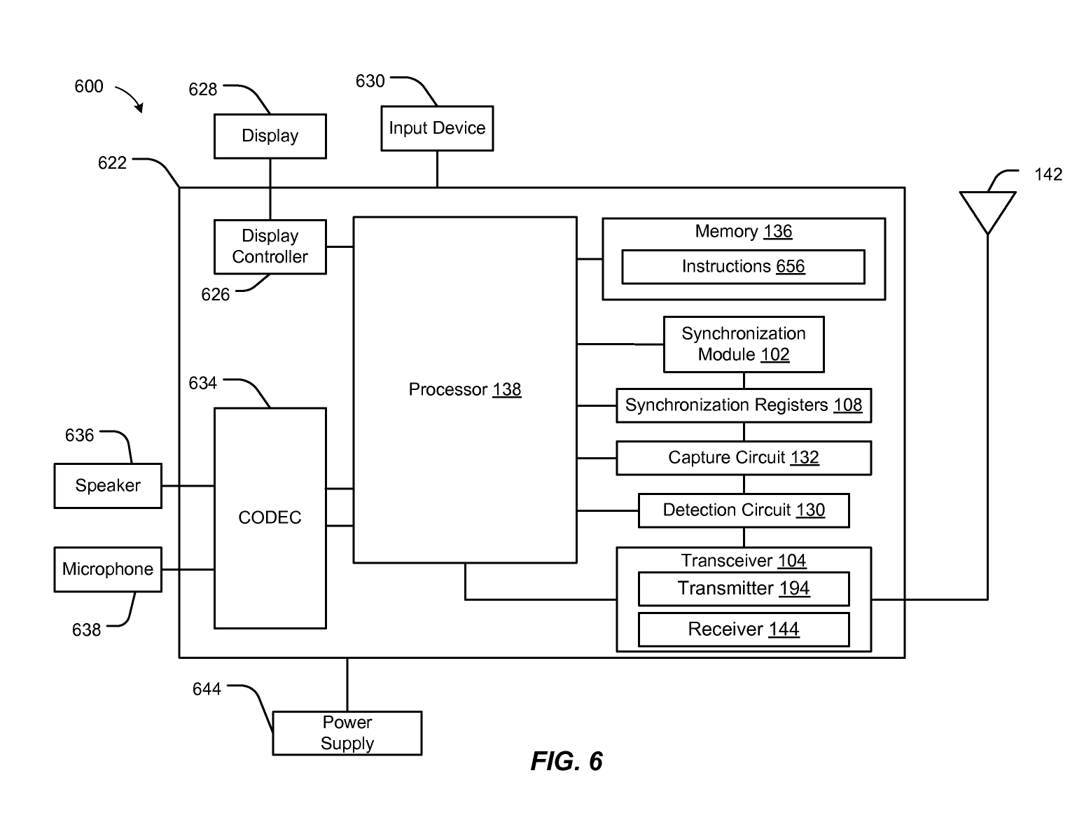

The method 400 of FIG. 4 may be implemented using a field-programmable gate array (FPGA) device, an application-specific integrated circuit (ASIC), a processing unit such as a CPU, a digital signal processor (DSP), a controller, another hardware device, firmware device, or any combination thereof. As an example, the method 400 of FIG. 4 may be performed using a processor that executes instructions, as described with respect to FIG. 6.

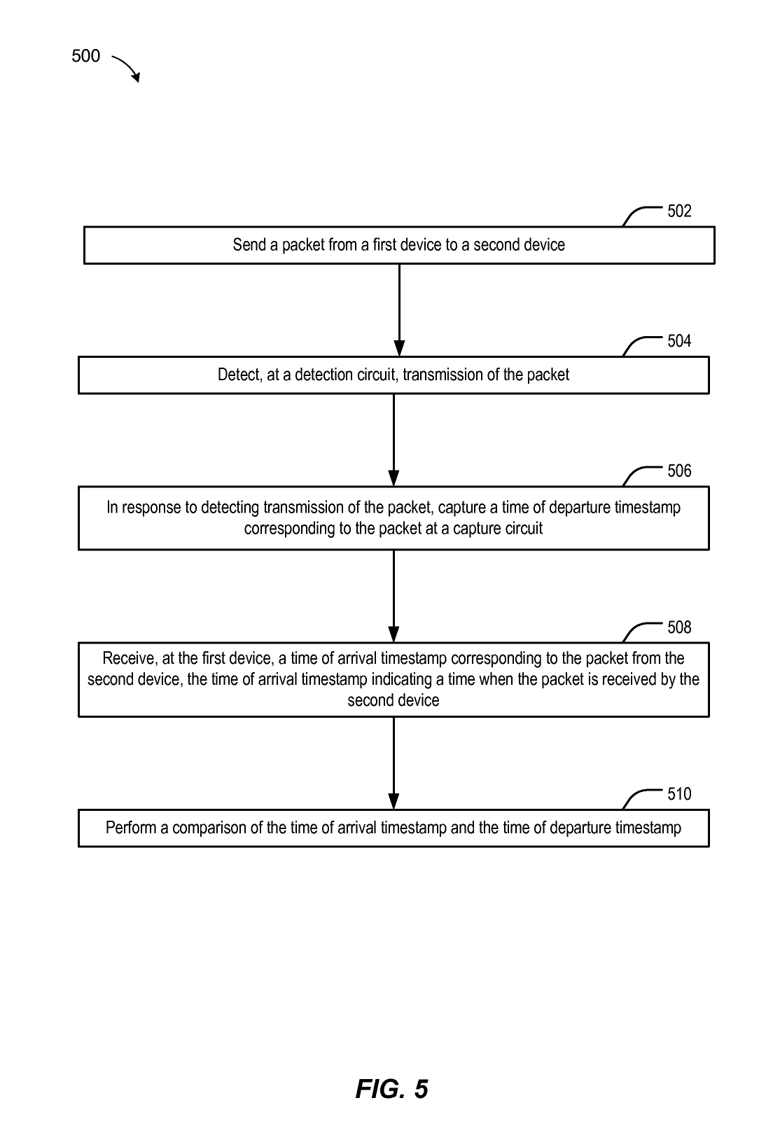

Referring to FIG. 5, a particular aspect of a method of network clock comparison is shown and generally designated 500. In a particular aspect, the method 500 may be performed by at least one of the systems 100-200 of FIGS. 1-2.

The method 500 includes sending a packet from a first device to a second device, at 502. For example, the first device 110 of FIG. 1 may send the packet 150 to the second device 120, as described with reference to FIG. 1.

The method 500 also includes detecting, at a detection circuit, transmission of the packet, at 504. For example, the detection circuit 130 of the first device 110 of FIG. 1 may detect transmission of the packet 150, as described with reference to FIG. 1. The detection circuit 130 may assert the first timestamp capture signal 114 in response to detecting transmission of the packet 150.

The method 500 further includes, in response to detecting transmission of the packet, capturing a time of departure timestamp corresponding to the packet at a capture circuit, at 506. For example, the capture circuit 132 of the first device 110 of FIG. 1 may capture the TOD timestamp 152 in response to the detection circuit 130 detecting transmission of the packet, as described with reference to FIG. 1. The capture circuit 132 may capture the TOD timestamp 152 in response to the first timestamp capture signal 114.

The method 500 also includes receiving, at the first device, a time of arrival timestamp corresponding to the packet from the second device, at 508. The time of arrival timestamp may indicate a time when the packet is received by the second device. For example, the receiver 144 of the first device 110 of FIG. 1 may receive the time of arrival (TOA) timestamp 124 from the second device 120, as described with reference to FIG. 1. The TOA timestamp 124 may indicate a time when the packet 150 is received by the second device 120, as described with reference to FIG. 1.

The method 500 further includes performing a comparison of the time of arrival timestamp and the time of departure timestamp, at 510. For example, the synchronization module 102 of the first device 110 of FIG. 1 may compare the TOA timestamp 124 and the TOD timestamp 152, as described with reference to FIG. 1.

The method 500 may thus enable the synchronization module 102 of the first device 110 to compare the TOD timestamp 152 corresponding to a time when the packet 150 is transmitted by the first device 110 and the TOA timestamp 124 corresponding to a time when the packet 150 is received by the second device 120.

The method 500 of FIG. 5 may be implemented using a FPGA device, an ASIC, a processing unit such as a CPU, a DSP, a controller, another hardware device, firmware device, or any combination thereof. As an example, the method 500 of FIG. 5 may be performed using a processor that executes instructions, as described with respect to FIG. 6.

Referring to FIG. 6, a block diagram of a particular illustrative aspect of a wireless communication device is depicted and generally designated 600. In a particular aspect, the device 600 may correspond to the first device 110, the second device 120, or both, of FIG. 1.

The device 600 includes the processor 138 coupled to the memory 136. The processor 138 may include a DSP or a CPU. The processor 138 may be coupled to, or may include, the synchronization module 102, the synchronization registers 108, the detection circuit 130, the capture circuit 132, or a combination thereof. The processor 138 may be coupled, via the transceiver 104, to the antenna 142. In a particular aspect, the transceiver 104 may include, or be coupled, to the receiver 144, the transmitter 194, or both. In a particular aspect, the synchronization module 102, the capture circuit 132, the detection circuit 130, the receiver 144, the transmitter 194, or a combination thereof, may perform at least a portion of the methods and operations described with reference to FIGS. 1-5.

The detection circuit 130 may detect that a first bit of a packet (e.g., the packet 150 of FIG. 1) is received or transmitted by the transceiver 104. The detection circuit 130 may assert a timestamp capture signal (e.g., the first timestamp capture signal 114 or the second timestamp capture signal 134 of FIG. 1). The capture circuit 132 may capture a timestamp (e.g., the TOA timestamp 124 or the TOD timestamp 152) in response to the timestamp capture signal (e.g., the first timestamp capture signal 114 or the second timestamp capture signal 134). For example, the capture circuit 132 may copy the timestamp (e.g., the TOA timestamp 124 or the TOD timestamp 152) from a clock register (e.g., the first clock register 112 or the second clock register 122 of FIG. 1) of the synchronization registers 108 to a shadow timestamp register (e.g., the first shadow timestamp register 116 or the second shadow timestamp register 126 of FIG. 1) of the synchronization registers 108. The receiver 144 may receive a corresponding timestamp (e.g., the TOD timestamp 152 or the TOA timestamp 124) from another device (e.g., the first device 110 or the second device 120) and may store the corresponding timestamp (e.g., the TOD timestamp 152 or the TOA timestamp 124) in the memory 136. The synchronization module 102 may read the timestamp (e.g., the TOA timestamp 124 or the TOD timestamp 152) from the shadow timestamp register (e.g., the first shadow timestamp register 116 or the second shadow timestamp register 126) and may read the corresponding timestamp (e.g., the TOD timestamp 152 or the TOA timestamp 124) from the memory 136. The synchronization module 102 may compare the timestamp (e.g., the TOA timestamp 124 or the TOD timestamp 152) and the corresponding timestamp (e.g., the TOD timestamp 152 or the TOA timestamp 124). In a particular aspect, the synchronization module 102 may perform clock synchronization based on the comparison, as described with reference to FIG. 1.

In a particular aspect, the synchronization module 102, the capture circuit 132, the detection circuit 130, the receiver 144, the transmitter 194, or a combination thereof, may be implemented on-chip, such as via one or more processors (e.g., the processor 138). For example, the capture circuit 132 and the detection circuit 130 may be implemented on a single chip or on distinct chips. In a particular aspect, the memory 136 may be a computer readable storage device storing computer-executable instructions 656 that are executable by the processor 138 to cause the processor 138 to perform operations of the synchronization module 102, the capture circuit 132, the detection circuit 130, the receiver 144, the transmitter 194, or a combination thereof. For example, the processor 138 may assert a timestamp capture signal (e.g., the first timestamp capture signal 114 or the second timestamp capture signal 134) in response to transmission of a first bit of a packet (e.g., the packet 150) or in response to a first bit of a packet (e.g., the packet 150) being received, may capture a timestamp (e.g., the TOA timestamp 124 or the TOD timestamp 152) in response to a timestamp capture signal, may receive a corresponding timestamp (e.g., the TOD timestamp 152 or the TOA timestamp 124), may compare the timestamp (e.g., the TOA timestamp 124 or the TOD timestamp 152) and the corresponding timestamp (e.g., the TOD timestamp 152 or the TOA timestamp 124), may perform clock synchronization based on the comparison, or a combination thereof, as described with reference to FIG. 1.

FIG. 6 also shows a display controller 626 that is coupled to the processor 138 and to a display 628. A coder/decoder (CODEC) 634 can also be coupled to the processor 138. A speaker 636 and a microphone 638 can be coupled to the CODEC 634. The microphone 638 may include an audio source device.

In a particular aspect, the processor 138, the display controller 626, the memory 136, the CODEC 634, the synchronization module 102, the synchronization registers 108, the capture circuit 132, the detection circuit 130, and the transceiver 104 are included in a system-in-package or system-on-chip device 622. In a particular aspect, an input device 630 and a power supply 644 are coupled to the system-on-chip device 622. The input device 630 may include a video source device. Moreover, in a particular aspect, as illustrated in FIG. 6, the display 628, the input device 630, the speaker 636, the microphone 638, the antenna 142, and the power supply 644 are external to the system-on-chip device 622. However, each of the display 628, the input device 630, the speaker 636, the microphone 638, the antenna 142, and the power supply 644 can be coupled to a component of the system-on-chip device 622, such as an interface or a controller.

Those of skill would further appreciate that the various illustrative logical blocks, configurations, modules, circuits, and algorithm steps described in connection with the aspects disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, but such implementation decisions are not be interpreted as causing a departure from the scope of the present disclosure.

The steps of a method or algorithm described in connection with the aspects disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A method comprising:
receiving, at a first device, a packet from a second device;
detecting receipt of the packet at a detection circuit;
in response to detecting the receipt of the packet, capturing a time of arrival timestamp corresponding to the packet at a capture circuit;
receiving, at the first device, a time of departure timestamp corresponding to the packet from the second device, the time of departure timestamp indicating a time when the packet is sent from the second device; and
performing a comparison of the time of arrival timestamp and the time of departure timestamp.

2. The method of claim 1, wherein the detection circuit is a first open systems interconnection model (OSI) layer circuit configured to operate at a first OSI layer, wherein the capture circuit is a second OSI layer circuit configured to operate at a second OSI layer, and wherein the first OSI layer is lower than the second OSI layer.

3. The method of claim 2, wherein the first OSI layer includes a data link layer, wherein the second OSI layer includes an application layer, and wherein the detection circuit detects receipt of the packet without decoding the packet.

4. The method of claim 1, wherein the detection circuit detects receipt of the packet based on detecting that a first bit of the packet is received, and wherein the first bit is an earliest received bit of the packet.

5. The method of claim 1, wherein the time of arrival timestamp is captured by copying the time of arrival timestamp from a first clock register to a shadow timestamp register, wherein the time of departure timestamp corresponds to a second clock register of the second device, and wherein the first clock register is related to an application.

6. The method of claim 5, further comprising synchronizing the first clock register and the second clock register based on the comparison.

7. The method of claim 5, wherein synchronizing the first clock register and the second clock register includes updating a value of the first clock register based on a difference between the time of arrival timestamp and the time of departure timestamp.

8. The method of claim 5, wherein synchronizing the first clock register and the second clock register includes determining an offset between the first clock register and the second clock register based on the time of arrival timestamp and the time of departure timestamp.

9. The method of claim 1, wherein the detection circuit asserts a timestamp capture signal in response to detecting the receipt of the packet, and wherein the capture circuit captures the time of arrival timestamp in response to the timestamp capture signal.

10. The method of claim 9, wherein the timestamp capture signal includes a hardware signal, a software signal, or both.

11. The method of claim 9, wherein the timestamp capture signal includes an interrupt signal.

12. The method of claim 9, wherein the detection circuit asserts a second timestamp capture signal in response to detecting transmission of a second packet, wherein the timestamp capture signal and the second timestamp capture signal are independent sideband probe signals.

13. The method of claim 9, wherein the timestamp capture signal includes an edge-triggered signal, and wherein the first device includes an audio source device, a video source device, or both.

14. An apparatus comprising:
a detection circuit configured to detect transmission of a packet to a device;
a capture circuit responsive to the detection circuit, the capture circuit configured to capture a time of departure timestamp corresponding to the packet in response to detecting, at the detection circuit, transmission of the packet;
a receiver configured to receive a time of arrival timestamp from the device, the time of arrival timestamp corresponding to the packet, wherein the time of arrival timestamp indicates a time when the packet is received by the device; and
a processor coupled to the detection circuit, the receiver, and the capture circuit, the processor configured to compare the time of arrival timestamp and the time of departure timestamp.

15. The apparatus of claim 14, wherein the detection circuit is further configured to assert a first timestamp capture signal in response to detecting the transmission of the packet, and wherein the capture circuit is further configured to capture the time of departure timestamp in response to the first timestamp capture signal.

16. The apparatus of claim 14, further comprising a first clock register and a first shadow timestamp register, wherein the time of departure timestamp is captured by copying the time of departure timestamp from the first clock register to the first shadow timestamp register.

17. The apparatus of claim 16, further comprising a memory, wherein the receiver is further configured to store the time of arrival timestamp in the memory, and wherein the processor is further configured to, prior to comparing the time of arrival timestamp and the time of departure timestamp:
read the time of arrival timestamp from the memory, and
read the time of departure timestamp from the first shadow timestamp register.

18. The apparatus of claim 16, wherein the time of arrival timestamp corresponds to a second clock register of the device, and wherein the processor is further configured to synchronize the first clock register and the second clock register based on a difference between the time of arrival timestamp and the time of departure timestamp.

19. The apparatus of claim 16, wherein the time of arrival timestamp corresponds to a second clock register of the device, and wherein the processor is further configured to synchronize the first clock register and the second clock register by determining an offset between the first clock register and the second clock register based on the time of arrival timestamp and the time of departure timestamp.

20. The apparatus of claim 14, wherein the processor is further configured to send the time of departure timestamp to the device.

21. The apparatus of claim 14, wherein the detection circuit is further configured to receive the packet from the processor and to provide the packet to a transmitter to transmit to the device, and wherein the detection circuit is further configured to assert a first timestamp capture signal in response to providing a first bit of the packet to the transmitter.

22. The apparatus of claim 14,
wherein the receiver is further configured to:
receive a second packet from the device, and
receive a second time of departure timestamp from the device, the second time of departure timestamp indicating a second time when the second packet is sent from the device,
wherein the detection circuit is further configured to detect receipt of the second packet by the receiver,
wherein the capture circuit is further configured to capture a second time of arrival timestamp corresponding to the second packet in response to detecting, at the detection circuit, the receipt of the second packet, and wherein the processor is further configured to compare the second time of arrival timestamp and the second time of departure timestamp.

23. The apparatus of claim 22, wherein the detection circuit is further configured to assert a second timestamp capture signal in response to detecting the receipt of the second packet by the receiver, and wherein the capture circuit is further configured to capture the second time of arrival timestamp in response to the second timestamp capture signal.

24. The apparatus of claim 22, further comprising a first clock register and a second shadow timestamp register, wherein the capture circuit is further configured to capture the second time of arrival timestamp by copying the second time of arrival timestamp from the first clock register to the second shadow timestamp register.

25. A computer-readable storage device storing instructions that, when executed by a processor, cause the processor to perform operations comprising:
receiving a packet from a device;
detecting receipt of the packet at a detection circuit;
in response to detecting the receipt of the packet, capturing a time of arrival timestamp corresponding to the packet at a capture circuit;
receiving a time of departure timestamp corresponding to the packet from the device, the time of departure timestamp indicating a time when the packet is sent from the device; and
performing a comparison of the time of arrival timestamp and the time of departure timestamp.

26. The computer-readable storage device of claim 25, wherein the time of arrival timestamp is captured by copying the time of arrival timestamp from a first clock register to a shadow timestamp register, wherein the time of departure timestamp corresponds to a second clock register of the device, and wherein the operations further comprise synchronizing the first clock register and the second clock register based on the comparison.

27. The computer-readable storage device of claim 26, wherein a plurality of time of arrival timestamps is captured by the capture circuit by copying the plurality of time of arrival timestamps from a first plurality of clock registers to a plurality of shadow timestamp registers,
wherein the plurality of time of arrival timestamps is captured by the capture circuit in response to detecting the receipt of the packet,
wherein the plurality of time of arrival timestamps includes the time of arrival timestamp,
wherein the first plurality of clock registers includes the first clock register, and
wherein the plurality of shadow timestamp registers includes the shadow timestamp register.

28. The computer-readable storage device of claim 27, wherein the operations further comprise:
receiving a plurality of time of departure timestamps of a second plurality of clock registers from the device, the plurality of time of departure timestamps indicating the time when the packet is sent from the device,
reading the plurality of time of arrival timestamps from the plurality of shadow timestamp registers, and
comparing the plurality of time of arrival timestamps and the plurality of time of departure timestamps,
wherein the plurality of time of departure timestamps includes the time of departure timestamp.

29. A device comprising:
a receiver configured to:
receive a packet from a second device; and
receive a time of departure timestamp from the second device, wherein the time of departure timestamp corresponds to the packet, and
wherein the time of departure timestamp indicates a time when the packet is sent from the second device;
a detection circuit coupled to the receiver and configured to detect receipt of the packet by the receiver;
a capture circuit responsive to the detection circuit, the capture circuit configured to capture a time of arrival timestamp in response to detecting, at the detection circuit, the receipt of the packet by the receiver; and
a processor coupled to the receiver and the capture circuit, the processor configured to perform a comparison of the time of arrival timestamp and the time of departure timestamp.

30. The device of claim 29, wherein the detection circuit is further configured to assert a timestamp capture signal in response to detecting the receipt of the packet by the receiver, and wherein the capture circuit is further configured to capture the time of arrival timestamp in response to the timestamp capture signal.
